(19) United States
(12) Patent Application Publication
(10) Pub. No.: US 2015/0072904 A1
(43) Pub. Date: Mar. 12, 2015

(54) Oil based mud system

(71) Applicant: Prime Eco Research and Development, LLC, Wharton, TX (US)

(72) Inventors: Orlando D'elia, Wharton, TX (US); Fernando Javier Guzman, Wharton, TX (US)

(73) Assignees: Prime Eco Group, Inc.; Prime Eco Research and Development, LLC, Wharton, TX (US)

(21) Appl. No.: 13/987,857

(22) Filed: Sep. 9, 2013

(51) Int. Cl. C09K 8/28

(52) U.S. Cl. CPC C09K 8/28
USPC 507/128; 507/129

(57) ABSTRACT

Emulsions usable within a wellbore as drilling fluids can be prepared by adding an internal phase to an external phase to form an emulsion base, and adding solid organophilizated mineral structures, a matrix stabilizing agent, a weighting agent, and a secondary stabilizer to the emulsion base. The solid organophilizated mineral structures stabilize the emulsion base and affect the rheology thereof, and the matrix stabilizing agent and the secondary stabilizer can retain the stability and viscosity of the emulsion base in the presence of hydrophilic solids. In addition to use as a wellbore fluid independently, usable emulsions can be compatible with and combined with traditional emulsions to form a mixture usable within a wellbore a drilling fluid.

### FIELD

Embodiments usable within the scope of the present disclosure relate, generally, to compositions (e.g., emulsions) usable within a wellbore (e.g., as a drilling mud) and methods for forming such compositions, and more specifically, to emulsions able to be effectively used within a wellbore that do not use traditional emulsifiers (e.g., liquid surfactants) that may present environmental concerns.

### BACKGROUND

When drilling a well (e.g., to recover hydrocarbons from the earth), the conventional practice is to rotate a drill bit using a string of attached tubular segments (e.g. drill pipe or casing) to form and extend a bore within the earth. To facilitate this process, a fluid, known as “drilling mud,” must be provided into the wellbore. Drilling mud cools and lubricates the drilling string and drill bit, counteracting much of the heat produced by friction during drilling operations and forming a barrier or cushion (e.g., a “filter cake”) between the walls of the wellbore and the drilling string, while also carrying debris formed by drilling (e.g., “cuttings”) away from the base of the wellbore to the surface. The type and characteristics of the drilling mud (e.g., viscosity, weight, etc.) used for a particular drilling operation can vary depending on the characteristics of the formation where the drilling operation is taking place (e.g., temperature, depth, wellbore stability, formation of gas hydrates, shale dispersion, etc.). Use of a suitable drilling mud can improve the rate of penetration of the drill bit and reduce or eliminate many difficulties inherent in the drilling process.

Some types of existing drilling muds include oil-in-water emulsions (an emulsion that includes water or a similar aqueous medium as a continuous phase, within which droplets of an organic compound are suspended as a discontinuous oil phase). Such emulsions normally include water, oil, emulsifiers (primary and secondary, wetting agents/surfactants, etc.), clays or polymers, various treating agents that control the physical, chemical, and/or rheological properties of the emulsion, and a weighting agent (e.g., barite, hematite, etc.) to provide the emulsion with a suitable weight for use as a drilling mud in a desired wellbore. Invert emulsions (water-in-oil emulsions, having a continuous oil phase within which discontinuous water/aqueous droplets are suspended) have also been found suitable for certain wellbore conditions, and in many cases have exhibited superior results when compared to water-based emulsions.

Independent of the components used in the continuous or discontinuous phases of an emulsion, conventional emulsions require use of emulsifiers to prevent separation of the phases (e.g., caused by settling and aggregation of droplets of the discontinuous phase over time). Emulsifiers have an amphiphilic molecular structure (e.g., having a polar/hydrophilic end and a nonpolar/lipophilic end, spatially separated from one another). Such emulsifiers act at the interface between the continuous and discontinuous phases of an emulsion and lower the interfacial tension. Specifically, at the boundary between phases (e.g., about the edges of droplets of the discontinuous phase), emulsifiers form interfacial films, which prevent coalescence of droplets of the discontinuous phase. Emulsifiers can include nonionic substances (e.g., soap) or ionic (cationic or anionic) compounds (e.g., quaternary ammonium compounds). For example, the hydrophilic molecular moiety of nonionic emulsifiers can include glycerol, polyglycerol, sorbitans, carbohydrates, and/or polyoxyethylene gloycols, and can be linked to a lipophilic molecular moiety via ester and/or ether bonds. The lipophilic molecular moiety of such emulsifiers can include fatty alcohols, fatty acids, and/or iso-fatty acids. By varying the structure and size of the hydrophilic and lipophilic moieties, the properties of the emulsifier can be varied within wide limits. Selection of an emulsifier suited to the components of an emulsion and the conditions within which the emulsion will be used is of significant importance.

A reduction in the amount of emulsifier necessary to stabilize an emulsion can be achieved through the addition of finely divided solid particles, which accumulate at the phase boundary. For example, “Pickering” emulsions were discovered in the early 1900s, through the preparation of paraffin/water emulsions that were stabilized by the addition of various solids, such as basic copper sulfate, basic iron sulfate, or other metal sulfates. The solid particles serve as a mechanical barrier against coalescence of droplets of the discontinuous phase, by becoming irreversibly anchored at this interface, where they develop strong lateral interactions. In some emulsions, it is possible to wholly replace conventional emulsifiers (e.g., organic surfactants) with solid particles. The nature and concentrations of the solid materials used, and the energy used during the mixing process, can affect the type and/or characteristics of the resulting emulsion. For example, use of solids having hydrophilic properties will typically form an oil-in-water emulsion, while use of solids having oleophilic properties will typically stabilize an inverted, water-in-oil emulsion.

It is often difficult to retain the stability of emulsions, when used as a drilling mud, due to the fact that weighting agents (e.g., barite) include hydrophilic solids, which can negatively affect the interfaces between phases of the emulsion. For example, when a water-in-oil/invert emulsion is stabilized using solid materials, the addition/presence of hydrophilic materials can serve to de-stabilize the emulsion.

A need exists for emulsions that can be made without traditional emulsifiers, thereby reducing negative environmental impact, usable as drilling mud of a desired weight, that can retain the stability and effectiveness of conventional emulsions, including stability at wellbore temperatures and conditions and when exposed to weighting agents and/or hydrophilic materials such as formation solids.

Embodiments usable within the scope of the present disclosure meet these needs.

### SUMMARY

Embodiments usable within the scope of the present disclosure include emulsions usable within a wellbore (e.g., as drilling mud and/or other fluids) and methods for producing and/or preparing such emulsions. An embodied emulsion can be prepared, generally, by adding an internal phase (e.g., an aqueous phase, such as water, brine, and/or alcohol) to an external phase (e.g., an oleaginous phase, such as diesel, mineral oil, synthetic oil, biodiesel products, etc.) to form an emulsion base. To stabilize the emulsion base and affect the rheology thereof, solid organophilizated mineral structures can be added. In an embodiment, such solid organophilizated mineral structures can include a clay (e.g., kaolin, smectite, and/or ilite clays) and a cationic amine (e.g., a quaternary amine, such as those usable as oil-wetting agents). The solid organophilizated mineral structures can be formed and/or used in-situ, and can migrate to interfaces between the internal and external phases.

A matrix stabilizing agent can be added to the emulsion base for further stability (e.g., in the presence of a hydrophilic weighting agent, formation solids, other hydrophilic solids, etc.), and to regulate the viscosity of the emulsion. In an embodiment, the matrix stabilizing agent can include a natural anphoteric surfactant with a mineral matrix, covered with an oleic fatty acid family of the oleics. A weighting agent (e.g., barite, hematite, or similar weighting agents) can be added, e.g., to provide the emulsion with a desired mud weight when used as a drilling mud.

A secondary stabilizer (e.g., a vegetable oil and/or an animal or plant fat, or another type of anphoteric surfactant able to coat solid particles in the emulsion) can be added, such that the secondary stabilizer and/or the matrix stabilizing agent operate to retain stability of the emulsion in the presence of the weighting agent (which can include hydrophilic solids), as well as in the presence of other materials that could negatively affect stability of the emulsion, such as formation solids and/or other hydrophilic solids in a wellbore.

In an embodiment, a polymer activator, such as propylene carbonate, can be added to the emulsion base to facilitate the activity of the solid organophilizated mineral structures in the absence of water. In an embodiment, a high temperature high pressure filter reducer, such as a copolymer (e.g., styrene-butadiene rubber) and/or an ethylic latex structure (e.g., pre-crosslinked substituted styrene-acrylate copolymer) can be added. Other filter reducers, such as asphalts (eg., gilsonites, Raphaelites) and/or lignites can also be used. Other additives can include viscosity affecting agents, such as an alkyl quaternary ammonium clay and/or a mixed mineral thixotrope.

While relative quantities of components can be varied depending on the specific use of the emulsion (e.g., the characteristics of a specific wellbore), in an embodiment, the ratio of the amount of the internal phase to that of the external phase can be range from 100% oil to a 95/5, 90/10, 85/15, 80/20, 75/25, 70/30, 60/40, 50/50, or 40/60 oil to water ratio. In an embodiment, the solid organopilizated mineral structures can be present in a concentration ranging from, 10 ppb (pounds per barrel) to 25 ppb, the matrix stabilizing agent can be present in a concentration ranging from 5 ppb to 10 ppb, the weighting agent can be present in a concentration ranging from 5 ppb to 10 ppb, and/or the secondary stabilizer can be present in a concentration ranging from 5 ppb to 10 ppb.

While the emulsion base can be used as a drilling mud having effective stability, strength, and filtrate values, in an embodiment, the emulsion base can be combined with a traditional emulsion (e.g., an emulsion that includes an internal phase, an external phase, a primary emulsifier, a secondary emulsifier, lime, brine, gel, a fluid loss control agent, and/or a weighting agent), for example, in a one to one ratio, to produce an emulsion mixture that exhibits favorable characteristics while possessing a smaller quantity of traditional emulsifiers than conventional alternatives.

### DETAILED DESCRIPTION OF THE EMBODIMENTS

Before explaining the present embodiments in detail, it is to be understood that the embodiments are not limited to the particular descriptions and that the embodiments can be practiced or carried out in various ways.

Embodiments usable within the scope of the present disclosure include emulsions (e.g., invert, water-in-oil emulsions) usable within a wellbore environment (e.g., as a drilling mud or other wellbore fluid), that can exhibit an effectiveness greater than or equal to conventional alternatives, while minimizing environmental impact due to the reduction or elimination of conventional emulsifiers. For example, a conventional emulsion will typically include an oil phase (e.g., diesel), a primary emulsifier, some quantity of lime, brine (typically calcium chloride or similar salts), a secondary emulsifier, a gel, a fluid loss control agent, and a sufficient quantity of weighting agent to provide the emulsion with a desired specific gravity (when used as a drilling mud/fluid).

Embodiments usable within the scope of the present disclosure can include an emulsion base having an internal phase (e.g., water, brine, and/or alcohol) and an external phase (e.g., diesel, mineral oil, synthetic oil, biodiesel products, and/or other similar organic/oleaginous compounds), that can be stabilized and provided with desirable rheological characteristics through the addition of solid organophilizated mineral structures. In an embodiment, such solid organophilizated mineral structures can include a cationic amine and a clay (e.g., a kaolin, smectite, and/or illite clay, including without limitation kaolinite (Al₂Si₂O₅(OH)₄), illite ((K,H₃O)(Al,Mg,Fe)₂(Si,Al)₄O₁₀[(OH)₂,(H₂O)], hallyosite (Al₂Si₂O₅(OH)₄), nacrite, montmorillonite ((Na,Ca)_{0.33}(Al,Mg)₂Si₄O₁₀(OH)₂.nH₂O), vermiculite ((MgFe,Al)₃(Al,Si)₄O₁₀(OH)₂.4H₂0), talc (Mg₃Si₄O₁₀(OH)₂), palygorskite ((Mg,Al)₂Si₄O₁₀(OH).4(H₂O)), dioctahedral smectite, and/or trioctahedral smectite). The cationic amine can include a quaternary amine, which can also function as an oil-wetting agent. For example, in an embodiment, one or more clay minerals can be mixed and/or blended with cationic amines, that carry a positive charge, some of which can include quaternary amines used as oil-wetting agents. Use of such solid organophilizated mineral structures can provide an alternative to conventional Pickering-type solids that is generally easier and less expensive to manufacture.

A matrix stabilizing agent can be added to retain the stability of the emulsion when exposed to hydrophilic solids, such as barite (e.g., when used as a weighting agent) and/or formation materials or other hydrophilic materials, and further to regulate the viscosity of the emulsion. In an embodiment, the matrix stabilizing agent can include a natural anphoteric surfactant with a mineral matrix, covered with an oleic fatty acid. The matrix stabilizing agent can function as a natural matrix that re-establishes the stability of the emulsion when the emulsion is exposed to hydrophilic solids.

For example, weighting agents (e.g., barite, hematite, etc.) added to the emulsion to provide it with a desired specific gravity (e.g., mud weight) can include hydrophilic solids. Further, the emulsion can become loaded with hydrophilic solids during use, such as formation solids.

A secondary stabilizer can be added to the emulsion base to further compensate for the presence of hydrophilic materials, e.g., when the emulsion is loaded with hydrophilic solids, such as formation solids and/or barite, etc. In an embodiment, the secondary stabilizer can include a vegetable oil (e.g., a liquid, non-hydrogenated vegetable oil) and/or fatty substances occurring in animal and plant tissues (e.g., yellow-brownish fats) that can include, e.g., phosphoric acid, choline, fatty acids, glycerol, glycolipids, triglycerides, phosphatidylcholine, phosphatidylethanolamine, phosphatidylinositol, phospholipids, or combinations thereof. Secondary stabilizers can include, without limitation, any anphoteric surfactant (e.g., natural anphoteric surfactants) able to coat particles of hydrophilic solids in the emulsion, thereby effectively transforming the solids into oleophilic solids.

Additional additives to complement the function of the emulsion can include a polymer activator, such as propylene carbonate, usable when the solid organophilizated mineral structures must act in the absence of water. In the absence of water, the solid organophilizated mineral structures are usable to stabilize the emulsion and affect the rheology thereof through similar interactions with the propylene carbonate, or another, similar polymer activator. In an embodiment, the emulsion can include one or more high temperature high pressure (HTHP) filter reducing agents, such as a co-polymer (e.g., a modified styrene-butadiene rubber), and/or a filter reducing agent that includes an ethylic latex structure (such as pre-crosslinked, substituted styrene acrylate copolymer, in liquid form), an asphalt (e.g., gilsonite, Raphaelites), and/or lignties. Further additives to affect viscosity of the emulsion can include an alkyl quaternary ammonium clay, a mixed mineral thixotrope (MMT), and/or mixtures of organophilizated litic products.

Embodied emulsions can be prepared by adding the internal phase (e.g., water, brine, and/or alcohol) of the desired emulsion to the external phase (e.g., diesel, mineral oil, synthetic oil, biodiesel products, etc.), and adding the solid organophilizated mineral structures to the emulsion base to stabilize the emulsion base and affect the rheology thereof. The solid organophilizated mineral structures can be pre-treated (e.g., by blending/mixing with cationic amines), and/or reacted in situ within the phases to form the emulsion. The matrix stabilizing agent can then be added to the emulsion, followed by the desired amount of a weighting agent, followed by the secondary stabilizer. In an embodiment, the quantities of matrix stabilizing agent and secondary stabilizer added can be determined by the quantity of weighting agent used (e.g., when the weighting agent includes a hydrophilic solid).

Table 1, below, describes three exemplary embodiments (M1, M2, M3) of emulsions usable within the scope of the present disclosure, each of the exemplary emulsions having approximately a 80/20 ratio of diesel to brine.

TABLE 1

| COMPONENT | M1 | M2 | M3 |
|---|---|---|---|
| External Phase (Diesel) (ml) | 250 | 250 | 250 |
| Internal Phase (Brine-CaCl₂) (ml) | 60 | 60 | 60 |
| Solid Organophilizated Mineral Structures (gr) | 20 | 25 | 30 |
| Matrix Stabilizing Agent (gr) | 10 | 10 | 10 |
| Weighting Agent (Barite) (gr) | 100 | 100 | 100 |
| Secondary Stabilizer (gr) | 5 | 5 | 5 |

Specifically, Table 1, above, describes the contents of approximately one barrel equivalent (350 ml) of the exemplary embodiments. To 250 milliliters of an external component (e.g., diesel), 60 milliliters of an internal phase (e.g., brine containing calcium chloride) can be added, followed by 20, 25, or 30 grams of solid organophilizated mineral structures, 10 grams of matrix stabilizing agent, 100 grams of weighting agent (e.g., barite), and 5 grams of secondary stabilizer. Components can be added, mixed, blended, and/or reacted in situ to form the resulting emulsions.

Table 2, below, describes the measured rheology of the three exemplary emulsions prepared by combining the contents described in Table 1, as well as the plastic viscosity, yield point, gel strength, and electric stability of the exemplary emulsions. Measurements for each reading are provided before hot rolling of each exemplary emulsion. Table 3, below, describes the measured parameters of the three exemplary emulsions at various revolutions per minute (ranging from 3 rpm to 600 rpm) after a period of hot rolling (e.g., 16 hours) at a temperature of 300 degrees Fahrenheit (149 degrees Centigrade).

TABLE 2

| PARAMETER | M1 | M2 | M3 |
|---|---|---|---|
| Shear Stress @600 rpm (lbf/100 ft\hat{ }2) | 49 | 76 | 104 |
| Shear Stress @300 rpm (lbf/100 ft\hat{ }2) | 29 | 49 | 69 |
| Shear Stress @6 rpm (lbf/100 ft\hat{ }2) | 5 | 10 | 16 |
| Shear Stress @3 rpm (lbf/100 ft\hat{ }2) | 4 | 9 | 14 |
| Gel Strength (10″/10′) (lbf/100 ft\hat{ }2) | 5/6 | 9/11 | 13/17 |
| Plastic Viscosity (cps) | 20 | 27 | 35 |
| Yield Point (lbf/100 ft\hat{ }2) | 9 | 22 | 34 |
| Electric Stability (V) | >2000 | >2000 | >2000 |

Table 3, below, describes the measured parameters of the three exemplary emulsions (M1, M2, M3) at various revolutions per minute (ranging from 3 rpm to 600 rpm) after a period of hot rolling (e.g., 15-16 hours) at a temperature of 300 degrees Fahrenheit (149 degrees Centigrade).

TABLE 3

| PARAMETER | M1 | M2 | M3 |
|---|---|---|---|
| Shear Stress @600 rpm (lbf/100 ft\hat{ }2) | 61 | 85 | 130 |
| Shear Stress @300 rpm (lbf/100 ft\hat{ }2) | 38 | 56 | 90 |
| Shear Stress @6 rpm (lbf/100 ft\hat{ }2) | 8 | 14 | 24 |
| Shear Stress @3 rpm (lbf/100 ft\hat{ }2) | 7 | 12 | 22 |
| Gel Strength (10″/10′) (lbf/100 ft\hat{ }2) | 7/9 | 11/13 | 22/34 |
| Plastic Viscosity (cps) | 23 | 29 | 42 |
| Yield Point (lbf/100 ft\hat{ }2) | 15 | 27 | 48 |
| Electric Stability (V) | >2000 | >2000 | >2000 |

Tables 1-3, above, illustrate the increase in rheology obtained through the presence of greater quantities of solid organophilizated mineral structures, accompanied by similar increases in gel strength, yield point, and plastic viscosity. All samples demonstrated acceptable electric stability.

Table 4, below, describes another exemplary embodiment (M4) of an emulsion usable within the scope of the present disclosure.

TABLE 4

| COMPONENT | M4 |
|---|---|
| External Phase (Diesel) (ml) | 350 |
| Internal Phase (Brine-CaCl₂) (ml) | 60 |
| Solid Organophilizated Mineral Structures (gr) | 30 |
| Matrix Stabilizing Agent (gr) | 10 |
| Weighting Agent (Barite) (gr) | 100 |
| Secondary Stabilizer (gr) | 5 |
| Filtrate Control Agent (gr) | 5 |

Table 4 illustrates an exemplary emulsion that includes a filtrate control agent (e.g., a modified lignite or similar clay having amines or a similar ionic component therewith), and a ratio of approximately 15:85 brine to diesel.

Table 5, below, describes the measured rheology of the exemplary emulsion (M4), prepared by combining the contents described in Table 4, as well as the plastic viscosity, yield point, gel strength, electric stability, HPHT filtrate rate, and the amount of water in the filtrate, associated with the exemplary emulsion. Measurements are provided at various revolutions per minute (ranging from 3 rpm to 600 rpm) after a period of hot rolling (e.g., 15-16 hours) at a temperature of 300 degrees Fahrenheit (149 degrees Centigrade).

TABLE 5

| PARAMETER | M4 |
|---|---|
| Shear Stress @600 rpm (lbf/100 ft\hat{ }2) | 57 |
| Shear Stress @300 rpm (lbf/100 ft\hat{ }2) | 36 |
| Shear Stress @6 rpm (lbf/100 ft\hat{ }2) | 8 |
| Shear Stress @3 rpm (lbf/100 ft\hat{ }2) | 7 |
| Gel Strength (10″/10′) (lbf/100 ft\hat{ }2) | 7/8 |
| Plastic Viscosity (cps) | 21 |
| Yield Point (lbf/100 ft\hat{ }2) | 15 |
| Electric Stability (V) | >2000 |
| Filtrate HPHT (500 dP, 300 F.) (ml/30 min) | 8.0 |
| Water in the filtrate (ml) | 0.0 |

Tables 1-5 illustrate that the exemplary embodiment M4, having a quantity of solid organophilizated mineral structures equal to that of embodiment M3, but a larger quantity of diesel, exhibited a slightly lower measured rheology, plastic viscosity, gel strength, and yield point. Of note, Table 5 illustrates that the exemplary embodiment M4 possessed acceptable electric stability, a filtrate HPHT rate of 8.0, and no water was found in the filtrate.

Table 6, below, describes three exemplary embodiments (M5, M6, M7) of emulsions usable within the scope of the present disclosure, each emulsion having a differing oil to water ratio, and differing quantities of solid organophilizated mineral structures.

TABLE 6

| COMPONENT/PARAMETER | M5 | M6 | M7 |
|---|---|---|---|
| External Phase (Diesel) (ml) | 280 | 250 | 218 |
| Internal Phase (Brine - CaCl₂) (ml) | 30 | 60 | 96 |
| Oil to Water Ratio | 90/10 | 80/20 | 70/30 |
| Solid Organophilizated Mineral Structures (gr) | 35 | 20 | 15 |
| Matrix Stabilizing Agent (gr) | 10 | 10 | 10 |
| Weighting Agent (Barite) (gr) | 100 | 100 | 100 |
| Secondary Stabilizer (gr) | 5 | 5 | 5 |

Specifically, Table 6, above, describes the contents of approximately one barrel equivalent (350 ml) of the exemplary embodiments. Embodiments M5, M6, and M7 include a progressively decreasing oil to water ratio, as well as a decreasing quantity of solid organophilizated mineral structures.

Table 7, below, describes the measured rheology of the exemplary emulsions (M5, M6, M7), prepared by combining the contents described in Table 6, as well as the plastic viscosity, yield point, gel strength, and electric stability associated with the exemplary emulsions. Measurements are provided at various revolutions per minute (ranging from 3 rpm to 600 rpm) after a period of hot rolling (e.g., 15-16 hours) at a temperature of 300 degrees Fahrenheit (149 degrees Centigrade).

TABLE 7

| PARAMETER | M5 | M6 | M7 |
|---|---|---|---|
| Shear eStress @600 rpm | 74 | 66 | 128 |
| (lbf/100 ft\hat{ }2) | | | |
| Shear Stress @300 rpm (lbf/100 ft\hat{ }2) | 48 | 42 | 83 |
| Shear Stress @6 rpm (lbf/100 ft\hat{ }2) | 11 | 9 | 13 |
| Shear Stress @3 rpm (lbf/100 ft\hat{ }2) | 10 | 8 | 10 |
| Gel Strength (10″/10′) (lbf/100 ft\hat{ }2) | 9/11 | 8/10 | 11/19 |
| Plastic Viscosity (cps) | 26 | 24 | 45 |
| Yield Point (lbf/100 ft\hat{ }2) | 22 | 18 | 38 |
| Electric Stability (V) | >2000 | >2000 | >2000 |

Tables 1-7 illustrate that the exemplary embodiments M5, M6, and M7, having progressively decreasing oil to water ratios and a progressively decreasing quantity of solid organophilizated mineral structures, generally exhibit an increase in measured rheology, plastic viscosity, gel strength, and yield point as the oil to water ratio decreases, with a small drop in values exhibited by embodiment M6, likely due to the decrease in the quantity of solid organophilizated mineral structures used. Each of embodiments M5, M6, and M7 exhibited acceptable electric stability.

Embodiments usable within the scope of the present disclosure can exhibit compatibility with traditional emulsions (e.g., emulsions that include an internal phase, an external phase, primary and secondary emulsifiers, lime, brine, gel, a fluid loss control agent, and/or a weighting agent). For example, in an embodiment, an emulsion can be prepared using any of the compositions described above (e.g., embodiment M8, shown in Table 10), and a traditional emulsion can be prepared, e.g., using the composition described below, for embodiment TE, in Table 8. The two emulsions (M8 and TE) can be combined (e.g., in a 50-50 ratio, or another desired ratio), and the resulting mixture of emulsions (M9) can be used in a wellbore (e.g., as a drilling mud/fluid) having enhanced properties.

Specifically, Table 8, below, describes the contents of approximately one barrel equivalent (350 ml) of a traditional emulsion (TE) that can be combined with embodiments described above, to form a mixture of emulsions usable within the scope of the present disclosure.

TABLE 8

| COMPONENT | TE |
|---|---|
| External Phase (Diesel) (ml) | 250 |
| Primary Emulsifier (ml) | 12 |
| Lime (gr) | 8 |
| Internal Phase (Brine - CaCl₂) (ml) | 60 |
| Secondary Emulsifier (ml) | 5 |
| Gel (gr) | 10 |
| Fluid Loss Control Agent (gr) | 6 |
| Weighting Agent (Barite) (gr) | 100 |

The traditional emulsion (TE) described above includes diesel as an external, oleaginous phase, brine (calcium chloride) as an internal, aqueous phase, and uses primary and secondary emulsifiers (e.g., organic surfactants, wetting agents, and/or other emulsifiers known in the art) to stabilize the emulsion, lime to add excess alkalinity, gel, one or more fluid loss control agents, and a weighting agent (e.g., barite). It should be understood that the traditional emulsion (TE) is only one exemplary embodiment, and that any conventional and/or traditional emulsion can be produced, e.g., for combination with other embodied emulsions, such as those described in Tables 1-7, above, and Table 10 below.

Table 9, below, describes the measured rheology of the exemplary traditional emulsion (TE), prepared by combining the contents described in Table 8, as well as the plastic viscosity, yield point, gel strength, and electric stability associated with the exemplary traditional emulsion. Measurements are provided at various revolutions per minute (ranging from 3 rpm to 600 rpm) after a period of hot rolling (e.g., 16 hours) at a temperature of 300 degrees Fahrenheit (149 degrees Centigrade).

TABLE 9

| PARAMETER | TE |
|---|---|
| Shear Stress @600 rpm (lbf/100 ft\hat{ }2) | 52 |
| Shear Stress @300 rpm (lbf/100 ft\hat{ }2) | 31 |
| Shear Stress @6 rpm (lbf/100 ft\hat{ }2) | 5 |
| Shear Stress @3 rpm (lbf/100 ft\hat{ }2) | 4 |
| Gel Strength (10″/10′) (lbf/100 ft\hat{ }2) | 5/6 |
| Plastic Viscosity (cps) | 21 |
| Yield Point (lbf/100 ft\hat{ }2) | 10 |
| Electric Stability (V) | >2000 |

Table 9, above, viewed in combination with Tables 1-8, illustrates that a traditional emulsion, while possessing acceptable characteristics, generally exhibits a lower measured rheology, gel strength, plastic viscosity, and yield point than many of the exemplary emulsions described herein.

Table 10, below, describes the contents of approximately one barrel equivalent (350 ml) of an exemplary emulsion (M8), can be combined with a traditional emulsion, such as embodiment (TE) described above, to form a mixture of emulsions usable within the scope of the present disclosure.

TABLE 10

| COMPONENT | M8 |
|---|---|
| External Phase (Diesel) (ml) | 250 |
| Internal Phase (Brine - CaCl₂) (ml) | 60 |
| Solid Organophilizated Mineral | 20 |
| Structures (gr) | |
| Matrix Stabilizing Agent (gr) | 10 |
| Weighting Agent (Barite) (gr) | 100 |
| Secondary Stabilizer (gr) | 5 |

Specifically, Table 10 describes the exemplary emulsion (M8) having approximately a 80/20 ratio of diesel to brine. To 250 milliliters of an external component (e.g., diesel), 60 milliliters of an internal phase (e.g., brine containing calcium chloride) can be added, followed by 20 grams of solid organophilizated mineral structures, 10 grams of matrix stabilizing agent, 100 grams of weighting agent (e.g., barite), and 5 grams of secondary stabilizer. Components can be added, mixed, blended, and/or reacted in situ to form the resulting emulsions.

Table 11, below, describes the measured rheology of the exemplary emulsion (M8), prepared by combining the contents described in Table 10, as well as the plastic viscosity, yield point, gel strength, and electric stability associated with the exemplary emulsion. Measurements are provided at various revolutions per minute (ranging from 3 rpm to 600 rpm) after a period of hot rolling (e.g., 16 hours) at a temperature of 300 degrees Fahrenheit (149 degrees Centigrade).

TABLE 11

| PARAMETER | TE |
|---|---|
| Shear Stress @600 rpm (lbf/100 ft\hat{ }2) | 60 |
| Shear Stress @300 rpm (lbf/100 ft\hat{ }2) | 37 |
| Shear Stress @6 rpm (lbf/100 ft\hat{ }2) | 8 |
| Shear Stress @3 rpm (lbf/100 ft\hat{ }2) | 7 |
| Gel Strength (10″/10′) (lbf/100 ft\hat{ }2) | 7/10 |
| Plastic Viscosity (cps) | 23 |
| Yield Point (lbf/100 ft\hat{ }2) | 14 |
| Electric Stability (V) | >2000 |

Table 11 illustrates that the embodied exemplary emulsion (M8) exhibits a higher measured rheology, gel strength, plastic viscosity, and yield point than the traditional emulsion (TE), described in Tables 8 and 9.

As described above, in an embodiment, a mixed emulsion, formed by mixing a quantity of a traditional emulsion (e.g., exemplary traditional emulsion TE), with a quantity of an embodied emulsion (e.g., exemplary embodiment M8) in a desired ratio (e.g., a 50-50 ratio) can be used, e.g., within a wellbore as a drilling mud/fluid. For purposes of this disclosure, such a “mixed emulsion,” itself, constitutes an embodiment usable within the scope of the present invention, in addition to each of the exemplary emulsions described above.

Table 12, below, describes the measured rheology plastic viscosity, yield point, gel strength, electric stability, HPHT filtrate rate, and the amount of water in the filtrate, of a blend/mixture of the exemplary emulsion (M8), prepared by combining the contents described in Table 10, as the exemplary traditional emulsion (TE), prepared by combining the contents described in Table 8, to form an emulsion mixture (M9). The exemplary emulsion mixture (M9) cam be formed by combining emulsion M8 and the traditional emulsion TE in a 50-50 ratio. Measurements are provided at various revolutions per minute (ranging from 3 rpm to 600 rpm) after a period of hot rolling (e.g., 16 hours) at a temperature of 300 degrees Fahrenheit (149 degrees Centigrade).

TABLE 12

| PARAMETER | M9 |
|---|---|
| Shear Stress @600 rpm (lbf/100 ft\hat{ }2) | 66 |
| Shear Stress @300 rpm (lbf/100 ft\hat{ }2) | 40 |
| Shear Stress @6 rpm (lbf/100 ft\hat{ }2) | 9 |
| Shear Stress @3 rpm (lbf/100 ft\hat{ }2) | 8 |
| Gel Strength (10″/10′) (lbf/100 ft\hat{ }2) | 10/21 |
| Plastic Viscosity (cps) | 26 |
| Yield Point (lbf/100 ft\hat{ }2) | 14 |
| Electric Stability (V) | >2000 |
| Filtrate HPHT (500 dP, 300 F.) (ml/30 min) | 2.2 |
| Water in the filtrate (ml) | 0.0 |

Tables 8-12 illustrate that the mixture (M9) of the exemplary traditional emulsion (TE) and the exemplary emulsion (M8) described in Table 10 exhibits a greater measured rheology, plastic viscosity, gel strength, and yield point than either the traditional emulsion (TE) or the exemplary embodiment (M8) used alone. The mixture (M9) exhibits acceptable electric stability and HPHT filtrate rate, and no water in the filtrate.

Embodiments usable within the scope of the present disclosure thereby provide emulsions and methods of preparation and/or manufacture thereof, that are environmentally-friendlier than conventional alternatives, able to be efficiently and easily manufactured, and are stable at high temperatures (e.g., 300 degrees Fahrenheit (about 150 degrees Centigrade)) and wellbore conditions. Additionally, embodied emulsions described herein can maintain stability in the presence of hydrophilic solids (e.g., barite, formation solids, etc.), and can be compatible with traditional emulsions. For example, a 50-50 mixture of a traditional emulsion with one exemplary embodiment usable within the scope of the present disclosure resulted in an embodied emulsion mixture exhibiting measured values more favorable than those of either individual emulsion.

While these embodiments have been described with emphasis on the embodiments, it should be understood that within the scope of the appended claims, the embodiments might be practiced other than as specifically described herein.

What is claimed is:

1. A method for preparing an emulsion usable within a wellbore, the method comprising the steps of:
adding an internal phase to an external phase to form an emulsion base;
adding solid organophilizated mineral structures to the emulsion base to stabilize the emulsion base and affect rheology thereof;
adding a matrix stabilizing agent to the emulsion base;
adding a weighting agent to the emulsion base; and
adding a secondary stabilizer to the emulsion base, wherein the matrix stabilizing agent, the secondary stabilizer, or combinations thereof retain stability of the emulsion base in the presence of the weighting agent, formation solids, hydrophilic solids, or combinations thereof.

2. The method of claim 1, wherein the solid organophilizated mineral structures comprise a clay and a cationic amine.

3. The method of claim 1, wherein the matrix stabilizing agent comprises an amphoteric surfactant with a mineral matrix covered with a fatty acid.

4. The method of claim 1, wherein the weighting agent comprises a hydrophilic solid.

5. The method of claim 1, wherein the secondary stabilizer comprises a vegetable oil, an animal or plant fat, or combinations thereof.

6. The method of claim 5, wherein the animal or plant fat comprises phosphoric acid, choline, a fatty acid, glycerol, glycolipids, triglycerides, phosphatidylcholine, phosphatidylethanolamine, phosphatidylinositol, a phospholipid, or combinations thereof.

7. The method of claim 1, further comprising the step of adding a polymer activator to the emulsion base to facilitate action of the solid organophilizated mineral structures in absence of water.

8. The method of claim 1, further comprising the step of adding a high temperature high pressure filter reducer.

9. The method of claim 8, wherein the high temperature high pressure filter reducer comprises a copolymer, an ethylic latex structure, asphalt, lignite, or combinations thereof.

10. The method of claim 1, further comprising the step of adding an alkyl quaternary ammonium clay, a mixed mineral thixotropic, or combinations thereof to the emulsion base to affect viscosity thereof.

11. The method of claim 1, further comprising the step of combining a second emulsion with the emulsion base to form an emulsion mixture.

12. The method of claim 11, wherein the second emulsion comprises an internal phase, an external phase, a primary emulsifier, and a secondary emulsifier.

13. The method of claim 12, wherein the second emulsion further comprises lime, brine, gel, a fluid loss control agent, a weighting agent, or combinations thereof.

14. The method of claim 11, wherein the step of combining the second emulsion with the emulsion base to form the emulsion mixture comprises combining the second emulsion and the emulsion base in a one to one ratio.

15. An emulsion usable within a wellbore, the emulsion comprising:
an emulsion base comprising an internal phase and an external phase;
solid organopilizated mineral structures disposed at interfaces between the internal phase and the external phase, wherein the solid organopilizated mineral structures stabilize the emulsion base and affect rheology thereof;
a matrix stabilizing agent;
a weighting agent; and
a secondary stabilizer, wherein the matrix stabilizing agent, the secondary stabilizer, or combinations thereof retain stability of the emulsion base in the presence of the weighting agent, formation solids, hydrophilic solids, or combinations thereof.

16. The emulsion of claim 15, wherein the solid organophilizated mineral structures comprise a clay and a cationic amine.

17. The emulsion of claim 16, wherein the clay comprises a kaolin clay, a smectite clay, an illite clay, kaolinite, illite, hallyosite, nacrite, montmorillonite, vermiculite, talc, palygorskite, dioctahedral smectite, trioctahedral smectite, or combinations thereof.

18. The emulsion of claim 15, wherein the cationic amine comprises a quaternary amine.

19. The emulsion of claim 15, wherein the matrix stabilizing agent comprises an anphoteric surfactant with a mineral matrix covered with a fatty acid.

20. The emulsion of claim 15, wherein the weighting agent comprises a hydrophilic solid.

21. The emulsion of claim 15, wherein the secondary stabilizer comprises a vegetable oil, an animal or plant fat, or combinations thereof.

22. The emulsion of claim 21, wherein the vegetable oil comprises a liquid non-hydrogenated vegetable oil.

23. The emulsion of claim 21, wherein the animal or plant fat comprises phosphoric acid, choline, a fatty acid, glycerol, glycolipids, triglycerides, phosphatidylcholine, phosphatidylethanolamine, phosphatidylinositol, a phospholipid, or combinations thereof.

24. The emulsion of claim 15, further comprising a polymer activator, wherein the polymer activator facilitates action of the solid organophilizated mineral structures in absence of water.

25. The emulsion of claim 24, wherein the polymer activator comprises propylene carbonate.

26. The emulsion of claim 15, further comprising a high temperature high pressure filter reducer.

27. The emulsion of claim 15, wherein the high temperature high pressure filter reducer comprises a copolymer, an ethylic latex structure, asphalt, lignite, or combinations thereof.

28. The emulsion of claim 27, wherein the copolymer comprises styrene-butadiene rubber.

29. The emulsion of claim 27, wherein the ethylic latex structure comprises a liquid pre-crosslinked substituted styrene-acrylate copolymer.

30. The emulsion of claim 15, further comprising a viscosity modifying agent comprising an alkyl quaternary ammonium clay, a mixed mineral thixotropic, or combinations thereof.

31. The emulsion of claim 15, wherein the external phase comprises diesel.

32. The emulsion of claim 15, wherein the internal phase comprises water, brine, alcohol, or combinations thereof.

33. The emulsion of claim 15, further comprising a second emulsion mixed with the emulsion base.

34. The emulsion of claim 33, wherein the second emulsion comprises an internal phase, an external phase, a primary emulsifier, and a secondary emulsifier.

35. The emulsion of claim 34, wherein the second emulsion further comprises lime, brine, gel, a fluid loss control agent, a weighting agent, or combinations thereof.

36. The emulsion of claim 33, wherein the second emulsion and the emulsion base are present in a one to one ratio.

37. The emulsion of claim 15, wherein the internal phase and the external phase are present in a ratio ranging from 3:20 to 1:4 to, respectively.

38. The emulsion of claim 15, wherein the solid organopilizated mineral structures comprise a concentration ranging from 0.06 grams per milliliter to 0.1 grams per milliliter.

39. The emulsion of claim 15, wherein the matrix stabilizing agent comprises a concentration raging from 0.03 grams per milliliter to 0.04 grams per milliliter.

40. The emulsion of claim 15, wherein the weighting agent comprises a concentration ranging from 0.3 to 0.4 grams per milliliter.

41. The emulsion of claim 15, wherein the secondary stabilizer comprises a concentration ranging from 0.01 to 0.02 grams per milliliter.

42. An emulsion usable within a wellbore, the emulsion comprising:
an oleaginous phase comprising diesel;
an aqueous phase comprising brine;
solid organopilizated mineral structures disposed at interfaces between the oleaginous phase and the aqueous phase, wherein the solid organopilizated mineral structures comprise a clay and a cationic amine, and wherein the solid organopilizated mineral structures stabilize the emulsion base and affect rheology thereof;
a matrix stabilizing agent an amphoteric surfactant with a mineral matrix covered with a fatty acid;
a weighting agent; and
a secondary stabilizer comprising a vegetable oil, an animal or plant fat, or combinations thereof, wherein the matrix stabilizing agent, the secondary stabilizer, or combinations thereof retain stability of the emulsion base in the presence of the weighting agent, formation solids, hydrophilic solids, or combinations thereof.
